(19) United States
(12) Patent Application Publication
(10) Pub. No.: US 2024/0097805 A1
(43) Pub. Date: Mar. 21, 2024

(54) METHOD FOR CONTROLLING BACKSCATTERING OF AN AMBIENT SIGNAL, DEVICE FOR IMPLEMENTING SAID CONTROL METHOD

(71) Applicant: ORANGE, Issy-les-Moulineaux (FR)

(72) Inventor: Dinh Thuy Phan Huy, Châtillon Cedex (FR)

(21) Appl. No.: 18/255,513

(22) PCT Filed: Nov. 30, 2021
(86) PCT No.: PCT/FR2021/052154

§ 371 Date: Jun. 1, 2023

(30) Foreign Application Priority Data
Dec. 2, 2020 (FR) 2012518

(51) Int. Cl. H04B 17/318; H04B 17/382

(52) U.S. Cl. CPC H04B 17/318; H04B 17/382; H04B 7/22

(57) ABSTRACT

A method for controlling the backscattering of an ambient signal emitted by an emitter device is described. The method is implemented by a transmitter device configured to backscatter the ambient signal and includes acquiring a measurement of power received from the emitter device, and evaluating a criterion consisting of at least checking whether a distance, counted from a position occupied by the transmitter device during the acquiring of the current measurement and in which a given reception quality value is attained for a signal obtained by backscattering the ambient signal, is in a given interval, where the distance of coverage being defined as a function of the measurement and the value. The ambient signal is backscattered only if the criterion is met.

### PRIOR ART

The present invention belongs to the general field of telecommunications. It more particularly relates to a method for controlling the backscattering of an ambient signal emitted by an emitter source. It also relates to a transmitter device configured to implement said control method as well as an ambient backscatter communication system including said transmitter device. The invention finds a particularly advantageous application, although without limitation, for applications of the type “Internet of Things” (IoT), particularly in the framework of communications called “terminal-to-terminal” communications (device-to-device communications or D2D communications).

The ambient backscatter communication technology is well known today. The main techniques on which this technology is based are described in particular in the document: “Ambient Backscatter Communications: A Contemporary Survey”, N. Van Huynh, D. Thai Hoang, X. Lu, D. Niyato, P. Wang, D. In Kim, IEEE Communications Surveys&Tutorials, vol. 20, no. 4, pp. 2889-2922, Fourthquarter 2018.

Conventionally, the backscattering of an ambient signal takes place between a transmitter device and a receiver device. The ambient signal concerned corresponds to a radio signal emitted, permanently or recurrently, in a given frequency band by a source distinct from said transmitter and receiver devices. For example, it can be a television signal, a mobile phone signal (3G, 4G, 5G), a Wi-Fi signal, a WiMax signal, etc.

To communicate with the receiver device, the transmitter device exploits the ambient signal to send data to said receiver device. More specifically, the transmitter device reflects the ambient signal towards the receiver device, possibly by modulating it by selectively connecting an antenna that equips it at distinct impedances. The signal thus reflected is called a “backscattered signal”, and is intended to be decoded by the receiver device (i.e. the receiver device extracts from the backscattered signal information transmitted by the transmitter device, for example in the form of bits).

The fact that no additional radio wave (in the sense of a wave other than the one derived from the ambient signal) is emitted by the transmitter device makes the ambient backscatter technology particularly attractive. Indeed, the energy cost of a communication is thus reduced, which is particularly important in the current context of the IoT where each object of everyday life is intended to become a communicating object.

Nevertheless, the conventional exploitation of the ambient backscatter communication technology takes place without control of the coverage that the transmitter device is able to provide (the source emits regardless of the coverage provided by the transmitter device). “Coverage” refers here to the extent of the area within which is achieved a quality of reception (achievable received quality) of the backscattered signal sufficient to guarantee correct decoding, by a possible receiver device positioned in said area, of information transmitted by the transmitter device.

The fact that the coverage of the transmitter device cannot be controlled is problematic. Indeed, when the transmitter device is not sufficiently lighted by the source (i.e. when the electromagnetic power received by the transmitter device from the source, via the ambient signal, is low), its coverage is restricted. This then results, for the transmitter device, in an unnecessary expenditure of energy since the information it can transmit by ambient backscattering can only be decoded with a very low probability.

Conversely, when the transmitter device is excessively lighted by the source (i.e. when the electromagnetic power received by the transmitter device from the source, via the ambient signal, is very high), its coverage is large. This has the effect of increasing the probability that the coverage of the transmitter device will overlap with that of another transmitter device. However, such superposition is a source of mutual interference between the transmitter devices concerned. Consequently, the probability that the decoding of this information is compromised increases.

More recently, it has been proposed to expand the conventional framework of use of the ambient backscatter communication technology by integrating it to the implementation of D2D communications. In more detail, it is the implementation, in addition to traditional modes of communications (upward/downward mode in which a terminal/a base station emits data to a base station/a terminal), of another mode called “backscatter mode”, in which two terminals communicate with each other by ambient backscattering. The addition of this backscatter mode advantageously makes it possible to discharge the network used for the traditional modes, and therefore desave frequency resources.

The switching from a traditional mode to said backscatter mode is conditional. Particularly, it is possible to evaluate, during a preliminary phase, a criterion consisting in verifying, on the receiver device side, whether the quality of reception of a backscattered signal is sufficient to ensure correct decoding of information transmitted by the transmitter device. If the criterion is verified, the switching from the traditional mode to said backscatter mode is validated (sending of a message from the receiver device to the transmitter device to signify this validation). It is therefore understood that the fact of authorizing the use of the ambient backscattering only on conditions makes it possible to control the coverage of the transmitter device (absence of ambient backscattering if the reception quality is insufficient). For more details concerning these aspects, those skilled in the art can refer to the document: “Wireless-Powered Device-to-Device Communications with ambient backscattering: performance modeling and analysis”, X. Lu, H. Jiang, D. Niyato, D. I. Kim, Z. Han, IEEE Transactions on Wireless Communications, vol. 17, no. 3, pp. 1528-1544, March 2018.

Nevertheless, these recent developments (evaluation of a criterion on the receiver device side in the framework of D2D communications) remain complex to implement. Indeed, exchanges of signals are necessary between the transmitter device and the receiver device to confirm that the backscatter mode can be implemented (the system formed of the transmitter and receiver devices is a closed-loop control system given the transmission of a backscattered signal and the sending of the validation message relating to said backscattered signal).

Furthermore, the evaluation of the criterion requires the implementation, by the receiver device, of complex calculations aiming to decode the backscattered ambient signal (extraction of information in the backscattered signal by implementing interference mitigation processing operations). These complex calculations are also carried out regardless of the final decision, namely validation or not of a switching to the backscatter mode.

### DISCLOSURE OF THE INVENTION

The present invention aims to overcome all or part of the drawbacks of the prior art, in particular those set out above, by proposing a solution that makes it possible to control the coverage of a transmitter device in a simpler manner than the solutions of the prior art. Consequently, the solution proposed by the invention also makes it easier to control the selective implementation of an ambient backscatter communication.

To this end, and according to a first aspect, the invention relates to a method for controlling the ambient backscattering of a signal, called “ambient signal”, emitted by an emitter device. Said method includes a phase called “current phase” implemented by a transmitter device configured to backscatter said ambient signal and comprising steps of:
acquisition of a measurement, called “current measurement”, of an electromagnetic power received from the emitter device via the received ambient signal,
evaluation of a criterion consisting in at least verifying whether a distance, called “coverage distance”, counted from a position occupied by the transmitter device during the acquisition of the current measurement and in which is achieved a given value, called “target value”, of quality of reception of a signal obtained by ambient backscattering of the ambient signal, is comprised in a given interval, said coverage distance being defined as a function of said current measurement and said target value,
if said criterion is satisfied, ambient backscattering of the ambient signal,
if said criterion is not satisfied, absence of ambient backscattering of the ambient signal.

The method according to the invention therefore proposes that it is the transmitter device that alone controls its coverage via said evaluation step.

More specifically, the transmitter device carries out, based on the acquired current measurement, calculations allowing it to evaluate whether the theoretical coverage distance in which is achieved the target value of the reception quality (achievable received quality) remains comprised in the given interval. In other words, the transmitter device thus performs a simulation of the coverage that it is able to provide when it is illuminated by the source under conditions that cause it to acquire said current measurement.

Thus, thanks to the method of the invention, the transmitter device is able to control its coverage on its own, without the assistance of another device, as it is done in the state of the art. The transmitter device therefore does not require, from any other device, confirmation as to the possibility of implementation of the backscattering of the ambient signal.

In particular modes of implementation, the control method can further include one or more of the following characteristics, taken in isolation or according to all the technically possible combinations.

In particular modes of implementation, said target value is a value of any one of the following quantities:
a signal to noise ratio,
a signal to interference plus noise ratio,
a bit error rate.

In particular modes of implementation, the ambient signal is characterized by:
a first spectral density when the step of acquisition of the current measurement is executed,
a second spectral density, distinct from said first spectral density, when the step of evaluation of the criterion is executed.

Furthermore, said coverage distance is also defined as a function of the ratio between said first and second power spectral densities.

Such provisions make it possible to take account variations in the conditions of illumination of the transmitter device by the emitter device. In this way, the transmitter device can achieve a finer control on its coverage, and therefore a fortiori also on the possibility of a backscattering of the ambient signal.

In particular modes of implementation, the transmitter device is configured to backscatter said ambient signal to at least one receiver device, said receiver device being configured to decode said backscattered ambient signal, said transmitter and receiver devices being respectively characterized by antenna gains G_TX and G_RX, said coverage distance also being defined as a function of said antenna gains G_TX and G_RX.

Knowing the values of such antenna gains allows the transmitter device to carry out an evaluation of the criterion from an analytical expression derived from the Friis equation.

In particular modes of implementation, said method includes, before the implementation of said current phase, a preliminary experimental phase during which the transmitter device is fixed and comprising steps of:
acquisition, by the transmitter device, of a measurement called “reference measurement”, of an electromagnetic power received from an emitter device emitting a signal called “experimental ambient signal”,
ambient backscattering of the experimental ambient signal by the transmitter device and to a receiver device configured to decode said backscattered experimental ambient signal, said preliminary experimental phase further comprising, during the execution of said ambient backscatter step, a search for a location at which the backscattered experimental ambient signal is received by the receiver device with a reception quality achieving said target value, the distance separating the receiver device from the transmitter device when such a location has been found being called “reference distance” and said coverage distance also being defined as a function of said reference measurement and said reference distance.

Such provisions allow the transmitter device to carry out an evaluation of the criterion from an alternative analytical expression compared to the one that can be used when the antenna gains G_TX, G_RX are given.

In particular modes of implementation, said current phase further includes a step of determination of the coverage distance, said at least one verification performed during the evaluation of the criterion consisting of a direct verification that the determined coverage distance belongs to said interval.

In particular modes of implementation, the interval associated with the coverage distance includes a lower bound and an upper bound, said current phase further including steps of:
determination of an electromagnetic power, called “minimum power” which, if it is received by the transmitter device from the emitter device, allows said target value to be achieved at a distance counted from the position occupied by the transmitter device during the acquisition of the current measurement and equal to said lower bound,
determination of an electromagnetic power, called “maximum power” which, if it is received by the transmitter device from the emitter device, allows said target value to be achieved at a distance counted from the position occupied by the transmitter device during the acquisition of the current measurement and equal to said upper bound,

said at least one verification performed during the evaluation of the criterion consisting in verifying whether the current measurement is comprised between said minimum and maximum powers.

In particular modes of implementation, the transmitter device is movable at a speed V between instants at which said steps of acquisition and evaluation of said current phase are executed, the evaluation of the criterion also consisting in verifying whether the duration separating said execution instants is sufficiently short compared to the ratio A/V, where A corresponds to the wavelength of the carrier frequency of the ambient signal, so that the electromagnetic power received by the transmitter device from of the emitter device via the ambient signal is substantially constant during said duration.

The fact of including carrying out such verification (in addition to the verification relating to the fact that the coverage distance belongs to the given interval) makes it possible to ensure that the illumination conditions of the transmitter device remain stable over time despite the fact that the latter is moving.

According to a second aspect, the invention relates to a computer program including instructions for the implementation of at least the steps of the current phase of a control method according to the invention when said program is executed by a computer.

This program can use any programming language, and be in the form of source code, object code or intermediate code between source code and object code, such as in a partially compiled form or in no any other desirable form.

According to a third aspect, the invention relates to a computer-readable information or recording medium on which a computer program according to the invention is recorded.

The information or recording medium can be any entity or device capable of storing the program. For example, the medium can include a storage means, such as a Flash type memory, for example a USB key or an SSD (Solid State Drive) disk, such as a ROM, for example a CD ROM or a microelectronic circuit ROM, or a magnetic recording means, such as a hard disk, for example an HDD (Hard Disk Drive) hard disk.

On the other hand, the information or recording medium can be a transmissible medium such as an electric or optical signal, which can be conveyed via an electric or optical cable, by radio or by other means. The program according to the invention can be particularly downloaded from an Internet-type network.

Alternatively, the information or recording medium can be an integrated circuit in which the program is incorporated, the circuit being adapted to execute or to be used in the execution of the method in question.

According to a fourth aspect, the invention relates to a transmitter device for controlling the ambient backscattering of a signal, called “ambient signal”, emitted by an emitter device. Said transmitter device is configured to backscatter said ambient signal and comprises:
an acquisition module configured to acquire a measurement, called “current measurement”, of an electromagnetic power received from the emitter device via the received ambient signal,
an evaluation module configured to evaluate a criterion consisting in at least verifying whether a distance, called “coverage distance”, counted from a position occupied by the transmitter device during the acquisition of the current measurement and at which is achieved a given value, called “target value”, of quality of reception of a signal obtained by ambient backscattering of the ambient signal, is comprised in a given interval, said coverage distance being defined as a function of said current measurement and of said target value,
a control module configured to implement/not to implement the backscattering of the ambient signal if said criterion is satisfied/not satisfied.

According to a fifth aspect, the invention relates to an ambient backscatter communication system, said system including an emitter device configured to emit an ambient signal and a transmitter device according to the invention.

### BRIEF DESCRIPTION OF THE DRAWINGS

Other characteristics and advantages of the present invention will become apparent from the description given below, with reference to the appended drawings which illustrate one exemplary embodiment devoid of any limitation. In the figures:

FIG. 1 schematically represents, in its environment, one particular embodiment of an ambient backscatter communication system according to the invention;

FIG. 2 schematically represents one example of hardware architecture of a transmitter device according to the invention belonging to the communication system of FIG. 1;

FIG. 3 represents, in the form of a flowchart, one particular embodiment of a control method according to the invention, as implemented by the transmitter device of FIG. 2;

FIG. 4 represents, in the form of a flowchart, another particular embodiment of the control method according to the invention;

FIG. 5 represents, in the form of a flowchart, still another particular embodiment of the control method according to the invention.

### DESCRIPTION OF THE EMBODIMENTS

FIG. 1 schematically represents, in its environment, one particular embodiment of an ambient backscatter communication system 10 according to the invention.

As illustrated in FIG. 1, the communication system 10 includes an emitter device, also called “source” SO, configured to emit, according to an emission frequency F_E comprised in a given frequency band called “emission band”, a radioelectric signal called “ambient signal”. The emission of the ambient signal is performed for example permanently or recurrently.

For the rest of the description, and as illustrated by FIG. 1, the case where the ambient signal is only emitted by a single source is considered without limitation. The choice consisting in considering a single source is made here only for the purpose of simplifying the description. Also, no limitation is attached to the number of sources that can be considered within the framework of the present invention, the following developments being indeed generalizable without difficulty by those skilled in the art in the case of a plurality of sources that are not consistent with each other.

By “radioelectric signal”, reference is made here to an electromagnetic wave propagating by non-wired means, whose frequencies are comprised in the traditional spectrum of the radioelectric waves (from a few hertz to several hundred gigahertz).

By way of non-limiting example, the ambient signal is a 4G mobile telephone signal emitted in the emission band [811 MHz, 821 MHz] by the source SO.

It should however be specified that the invention remains applicable to other types of radioelectric signals, such as for example a mobile telephone signal other than 4G (for example 2G, 3G, 5G), a Wi-Fi signal, a WiMax signal, a DVB-T signal, etc. In general, no limitation is attached to the ambient radio signal that can be considered within the framework of the present invention as long as the latter can be exploited to communicate by ambient backscattering.

The communication system 10 also includes a transmitter device D_TX and a receiver device D_RX respectively configured in order to communicate with each other by ambient backscattering from the ambient signal emitted by the source SO. It should be noted that, in accordance with the invention, the transmitter D_TX and receiver D_RX devices are distinct from each other as well as from the source SO.

In the following description, and as illustrated by FIG. 1, it is considered without limitation that the communication system 10 comprises a single transmitter device D_TX and a single receiver device D_RX. It should however be specified that the invention is also applicable to a communication system comprising a plurality of transmitter devices and/or a plurality of emitter devices, the developments necessary for such a generalization being able to be implemented without difficulty by those skilled in the art.

Furthermore, and as described in more detail later, nothing excludes envisaging the case where no receiver device is present, as long as the transmitter device D_TX is able to control the coverage that it is able to provide in the framework of an ambient backscatter communication.

In a manner known per se, the ambient backscatter communication consists in the exploitation of the ambient signal, by the transmitter device D_TX, to send an information data to said receiver device D_RX, such as for example an identification data specific to said transmitter device D_TX.

In the present embodiment, the transmitter device D_TX is equipped with an antenna (not represented in FIG. 1) configured, in a manner known per se, to receive the ambient signal but also to backscatter it to the receiver device D_RX. It should however be noted that the invention remains applicable in the case where the transmitter device D_TX includes a plurality of antennas.

The transmission of the backscattered signal by the transmitter device D_TX is performed by variation of the backscattering of the ambient signal, this variation being based on the possibility for the transmitter device T to modify the impedance presented to the antenna that equips it, as a function of the information data to be transmitted.

More specifically, the transmitter device D_TX can be associated with operating states as a function of the impedance presented to the antenna with which it is fitted. For the rest of the description, it is considered in a non-limiting manner that these states are a state called “backscatter” state (the transmitter device T can backscatter the ambient signal), as well as a contrary state called “non-backscatter” state (the transmitter device T cannot backscatter the ambient signal or, in other words, is “transparent” to the ambient signal). The impedance associated with the backscatter state typically corresponds to zero or infinite impedance, whereas the impedance associated with the non-backscatter state typically corresponds to the complex conjugate of the characteristic impedance of the antenna in the considered propagation medium and at the considered frequency.

It is important to note that the invention is not limited to this ideal case in which only two states, respectively perfectly backscatter state and perfectly non-backscatter state, would be considered. Indeed, the invention also remains applicable in the case where at least two states (first state and second state) are not perfectly backscatter/non-backscatter states, as long as the variation of the backscattered waves is perceptible by the receiver device D_RX when it is positioned at an appropriate distance from the transmitter device D_TX.

An information data intended to be transmitted by the transmitter device D_TX, by means of the backscattered signal, is conventionally encoded by means of a set of symbols, comprising for example a symbol called “high” symbol (bit of value “1”), or a symbol called “low” symbol (bit of value “0”). The transmission of such an information data can therefore be performed, in a manner known per se, by alternation between said backscatter and non-backscatter states, each of said states being dedicated to the transmission of a symbol of a particular type (for example high symbol for the backscatter state and low symbol for the non-backscatter state, or vice versa). In other words, an information data is transported to the receiver device D_RX by modulation of the waves of the ambient signal (i.e. by backmodulation).

In the present embodiment, the receiver device D_RX is also equipped with a reception antenna (not represented in the figures) configured to receive signals directly from the source SO as well as backscattered signals from the transmitter device D_TX. It should however be noted that the invention remains applicable in the case where the transmitter device D_TX includes a plurality of antennas.

In general, no limitation is attached to the structural forms that can be taken respectively by the source SO, the transmitter device D_TX and the receiver device D_RX. By way of non-limiting examples, the following configurations can be envisaged (depending on the considered emission frequency band):
the source SO is a base station, and the transmitter device D_TX (respectively the receiver device D_RX) is a cell phone, for example of the Smartphone type, or a touch pad or a personal digital assistant or a personal computer, etc.
the source SO (respectively the transmitter device D_TX) is a cell phone, for example of the Smartphone type, or a touch pad or a personal digital assistant or a personal computer, etc., and the receiver device D_RX is a base station,
the source SO, the transmitter device D_TX and the receiver device D_RX are all three cell phones, for example of the Smartphone type,
the source SO is a home gateway (also called “Internet box”) emitting a Wi-Fi signal, and the transmitter device D_TX (respectively the receiver device D_RX) is a cell phone, for example of the Smartphone type, or a touch pad or a personal digital assistant or a personal computer, etc., able to communicate according to the Wi-Fi protocol.

The processing operations aiming to backscatter the ambient signal (respectively decoding the backscattered signal) are conventionally performed by the transmitter device D_TX (respectively the receiver device D_RX), by implementing a backscatter method (respectively a decoding method) not represented in the figures.

For this purpose, the transmitter device D_TX (respectively the receiver device D_RX) includes for example one or more processors and storage means (magnetic hard disk, electronic memory, optical disk, etc.) in which are stored data and a computer program, in the form of a set of program code instructions to be executed to implement the backscatter method (respectively the decoding method).

Alternatively or additionally, the transmitter device D_TX (respectively the receiver device D_RX) also includes one or several programmable logic circuits, of the FPGA, PLD, etc. type, and/or specialized integrated circuits (ASIC), and/or a set of discrete electronic components, etc. adapted to implement the backscatter method (respectively the decoding method).

In other words, the transmitter device D_TX (respectively the receiver device D_RX) includes a set of means configured in software (specific computer program) and/or hardware (FPGA, PLD, ASIC, etc.) to implement the backscatter method (respectively the decoding method).

The specific aspects concerning the signal processing techniques for the transmission of data by ambient backscattering as well as the decoding of these data are known and for example detailed in the document by N. Van Huynh et al. already mentioned before.

As regards more specifically the decoding of the backscattered signal, it is known that it can only be implemented if the electromagnetic power variation, called “power deviation” E_P, received by the receiver device D_RX depending on whether the transmitter device D_TX is in a backscatter or non-backscatter state is, in absolute value, greater than a determined threshold, called “power threshold” S_P. In other words, said power threshold S_P determines the value of the power deviation E_P from which the receiver device D_RX is able to decode a signal backscattered by the transmitter device D_TX. Therefore, it is understood that the power threshold S_P is representative of a reception quality desired for the backscattered signal.

It should however be noted that although the decoding can be theoretically implemented as long as |E_P|>S_P, nothing prevents a more restrictive decoding condition from being imposed on the receiver device D_RX, such as |E_P|>N×S_P where N is a real number strictly greater than 1. Imposing a more restrictive condition makes it possible to increase the quality of communication between the transmitter D_TX and receiver D_RX devices, but this also limits the quantity of data likely to be exchanged between these devices. In general, those skilled in the art know what range of values can be considered for the absolute value of the power deviation E_P so that the operation of the system 10 is not compromised.

The power threshold S_P can be defined in different ways. Thus, according to one exemplary embodiment, the power threshold S_P is defined from a value of a Signal to Noise Ratio “SNR_RX” on the receiver device DRX side.

According to another example, the power threshold S_P is defined from a value of a Signal to Interference plus Noise Ratio “SINR_RX” on the receiver device D_RX side.

However, nothing excludes considering other quantities to define said power threshold, such as for example a decoding error rate “BER_RX” (acronym of Bit Error Rate). Concerning these aspects, those skilled in the art can refer to the document: “Real-Time Ambient Backscatter Demonstration”, K. Rachedi, D. T. Phan-Huy, N. Selmene, A. Ourir, M. Gautier, A. Gati, A. Galindo-Serrano, R. Fara, J. De Rosny, IEEE INFOCOM 2019 Posters and Demos, 1 May 2019, Paris, France.

As mentioned before, the power threshold S_P is representative of a reception quality desired for the backscattered signal. Consequently, the quantities from which the power threshold S_P can be defined (SNR_RX, SINR_RX, BER_RX, etc.) also inherit this characteristic. In other words, the fact of setting a value, called “target value” VAL_C, for such a quantity on the receiver device D_RX side makes it possible to define a reception quality expected for the backscattered signal.

For the rest of the description, it is considered that the quantity chosen to evaluate the quality of reception of the backscattered signal is the signal to noise ratio SNR_RX. Thus, with regard to the foregoing, the target value VAL_C considered below corresponds to a value of said signal to noise ratio SNR_RX.

It should however be noted that it is possible to express a quantity among a signal to noise, a signal to interference plus noise, a bit error rate as a function of another of said quantities. This is classically done by means of an analytical function specific to the considered quantities. In other words, the choice according to which said reception quality is evaluated by means of the signal to noise SNR_RX only constitutes a variant of implementation of the invention, and it is completely equivalent to take into account a quantity other than the signal to noise ratio SNR_RX.

The signal to noise ratio SNR_RX is classically defined as follows:

$$SNR\_RX = \frac{P ( D\_RX )}{P\_NOISE ( D\_RX )}$$

expression in which:
P(D_RX) is the electromagnetic power received by the receiver device D_RX at its antenna and coming from the transmitter device D_TX,
P_NOISE(D_RX) is a coefficient corresponding to the adaptation losses at the level of the emitter device D_RX

The target value VAL_C for its part can be formulated analytically using the Friis equation. More specifically, we have:

$$VAL\_C = {( \frac{λ}{4 \times π \times d} )}^{2} \times [ r \times G\_TX \times G\_RX \times \frac{P ( D\_TX )}{P\_NOISE ( D\_TX )} ]$$

expression in which:
P(D_TX) is the electromagnetic power received by the transmitter device D_TX at the level of its antenna and coming from the source SO,
P_NOISE(D_TX) is a coefficient corresponding to the adaptation losses at the level of the transmitter device D_TX,
λ is the wavelength of the carrier frequency of the ambient signal,
r is a coefficient (comprised between 0 and 1) of a power transmission of the transmitter device D_TX. In particular, r is defined as a function of the impedance of the antenna equipping the transmitter device D_TX,
G_RX is the gain of the antenna equipping the receiver device D_RX,
G_TX is the gain of the antenna equipping the transmitter device D_TX,
d is the distance separating the transmitter device D_TX from the receiver device D_RX.

For information purposes, it is noted that the coefficient P(D_TX)/P_NOISE(D_TX) corresponds to a value (denoted “VAL_M” hereafter) of the signal to noise ratio on the transmitter device D_TX side. This signal to noise ratio is for its part denoted “SNR_TX” in the remainder of the description.

It is important to note that, for reasons of simplification of the description, the analytical expression given above for the target value VAL_C of the signal to noise ratio SNR_RX is an expression in which not all of the parameters that could be theoretically taken into account appear. Indeed, in this analytical expression, it is considered that the respective antennas of the transmitter D_TX and receiver D_RX devices are correctly aligned in terms of polarization of the electromagnetic field. It would nevertheless be possible to generalize this analytical expression by adding (in the rightmost member in square brackets) a multiplicative coefficient corresponding to the polarization efficiency. These aspects are known to those skilled in the art.

Also for reasons of simplification of the description, it is considered in the present embodiment and with regard to the analytical formulation of the target value VAL_C, that the spectral density (expressed in Watts per Hertz) of the ambient signal remains substantially constant over time.

Nevertheless, the variation of said spectral density could also be taken into account (this is however not the case in the remainder of the description). For example, if it is assumed that the ambient signal is characterized by:
a first spectral density DSP1 in an instant called “first instant”, in which a measurement of the quantity P(D_TX) is acquired,
a second spectral density DSP2 for any instant greater than said first instant, then, if the target value VAL_C is calculated subsequently to said first instant, said analytical expression becomes:

$$VAL\_C = {( \frac{λ}{4 \times π \times d} )}^{2} \times [ r \times G\_TX \times G\_RX \times \frac{P ( D\_TX )}{P\_NOISE ( D\_TX )} \times \frac{D S P 2}{DSP 1} ]$$

The distance d considered in the analytical expression given above corresponds to the distance, counted from the transmitter device D_TX, at which is achieved said target value VAL_C of the signal to noise ratio SNR_RX. In other words, said distance d represents the coverage of the transmitter device D_RX for a target value set to VAL_C. For the rest of the description, said distance d is therefore called “coverage distance”, as denoted “D_COUV”.

Given the writing elements considered above, it is possible to give the following analytical expression for the coverage distance D_COUV:

$$D\_COUV = \frac{λ}{4 \times π} \times {[ r \times G\_TX \times G\_RX \times \frac{VAL\_M}{VAL\_C} ]}^{1 / 2}$$

Within the framework of the present invention, the transmitter device D_TX is associated with a coverage constraint. This coverage constraint corresponds to an interval I_COUV in which the coverage distance D_COUV must be comprised so that the backscattering of the ambient signal, by said transmitter device D_TX, is implemented. It is therefore understood that the fact of imposing such a coverage constraint, to decide whether the ambient backscattering should be implemented or not, ultimately amounts to exercising a control of said ambient backscattering.

To this end, the transmitter device D_TX is configured not only to backscatter the ambient signal, as already mentioned before, but also to carry out processing operations aiming to control the implementation of said backscattering of the ambient signal, by implementing steps of a control method according to the invention.

No limitation is attached to the way in which the lower D_MIN and upper D_MAX bounds of the interval I_COUV associated with said coverage constraint are calculated. For example, once the upper bound D_MAX has been chosen, the lower bound D_MIN is deduced from the upper bound D_MAX by application of a tolerance coefficient. Such a tolerance coefficient can for example correspond to a multiplicative coefficient (e.g.: D_MAX×0.9). Of course, nothing excludes envisaging other types of coefficients, such as for example a subtractive coefficient applied to D_MAX.

In practice, the bounds D_MIN and D_MAX can be defined according to the context in which the invention is implemented.

For example, if it is provided that the control method of the invention is implemented by a large number of transmitter devices, the upper bound D_MAX can be chosen substantially equal to one meter. Such a value makes it possible to ensure that a receiver device will decode the signal backscattered by a transmitter device only when it is close to the latter (i.e. at a distance comprised between said lower D_MIN and upper D_MAX bounds). In this way, the mutual interference between transmitter devices is minimized at the level of the receiver device, which increases the probability of achieving a correct decoding.

It is noted that the fact of considering that the upper bound D_MAX is substantially equal to one meter also applies advantageously when a large number of receiver devices are located in the environment of the transmitter device(s) implementing the control method according to the invention. Indeed, in this case, this makes it possible to limit the probability that a backscattered signal will be decoded by a receiver device not intended to receive said backscattered signal. The security of the communications between two devices is therefore enhanced.

Moreover, for this type of context aiming to guarantee the security of communications, it is of course possible to envisage an upper bound D_MAX of less than one meter, such as ten centimeters for example. Being able to envisage such a small upper bound D_MAX is particularly advantageous for applications in which the communications are intended to take place over very short distances, such as for example contactless purchases.

Conversely, and according to another example, if it is provided that the control method of the invention is implemented by a small number of transmitter devices, the upper bound D_MAX can be increased compared to the previous examples, and be for example chosen substantially equal to ten meters. In this way, the communication range (and therefore the coverage) of a transmitter device is advantageously increased.

In general, no limitation is attached to the values that can be taken by said lower D_MIN and upper D_MAX bounds. Those skilled in the art know indeed which values can be envisaged according to the context of application of the invention.

FIG. 2 schematically represents an example of hardware architecture of the transmitter device D_TX belonging to the system 10 of FIG. 1, for the implementation of said control method.

As illustrated in FIG. 2, the transmitter device D_TX has the hardware architecture of a computer. Thus, the transmitter device D_TX includes, in particular, a processor 1, a random access memory 2, a read only memory 3 and a non-volatile memory 4. It also includes a communication module 5.

The read only memory 3 of the transmitter device D_TX constitutes a recording medium in accordance with the invention, readable by the processor 1 and on which is recorded a computer program PROG in accordance with the invention, including instructions for the execution of at least part of the steps of the control method according to the invention. The program PROG defines functional modules of the transmitter device D_TX, which relies on or controls the hardware elements 1 to 5 of the transmitter device D_TX mentioned above, and which comprise in particular:
an acquisition module MOD_ACQ configured to acquire an electromagnetic power measurement received from the source SO via the ambient signal,
a determination module MOD_DET configured to determine the coverage distance D_COUV in accordance with the analytical expression mentioned above (said coverage distance D_COUV being counted from a position occupied by the transmitter device D_TX during the acquisition of said measurement and at which the target value VAL_C is achieved, the coefficient VAL_M being for its part calculated as a function of said acquired measurement),
an evaluation module MOD_EVAL configured to evaluate a criterion CRIT consisting of at least verifying whether the coverage distance D_COUV is comprised in the interval I_COUV,
a control module MOD_CONT configured to implement/not to implement the backscattering of the ambient signal if said criterion CRIT is satisfied/not satisfied.

The communication module 5 in particular allows the transmitter device D_TX to communicate with the receiver device D_RX, and for this purpose integrates the antenna equipping said transmitter device D_TX. Nothing however excludes envisaging, according to other examples not detailed here, that the communication module 5 is also configured to allow the transmitter device D_TX to communicate with devices other than the receiver device D_RX, such as with the source SO, following any technically possible communication protocol.

Conventionally, the acquisition module MOD_ACQ includes an acquisition chain connected to a sensitive element configured to provide an analog electric signal representative of the measured electromagnetic power. In the present exemplary embodiment, said sensitive element corresponds to the antenna equipping the transmitter device D_RX.

Said acquisition chain includes, for example, an acquisition card configured to condition said electric signal. The conditioning implemented by the acquisition card includes for example, in a manner known per se, amplification and/or filtering and/or current-power conversion. In general, the configuration of such an acquisition module MOD_ACQ is well known to those skilled in the art, and is therefore not detailed here further.

The criterion CRIT can include one or more conditions to be verified, including in particular the condition according to which the coverage distance D_COUV belongs to the interval I_COUV.

Thus, and according to a first example, the criterion CRIT includes a single condition to be verified (it is therefore the aforementioned condition relating to the coverage distance D_COUV).

The implementation of such an example turns out to be preferred when the transmitter device D_TX is fixed. Indeed, it is understood that the fact of considering the transmitter device D_TX to be fixed makes it possible to guarantee that the conditions of illumination of the latter by the source SO do not vary over time (except in case of modification of the spectral density of the ambient signal, this aspect being dealt with above).

According to a second example, the criterion CRIT includes two conditions to be verified. A first condition relating to said coverage distance D_COUV (this first condition is identical to the one mentioned in the previous example), and a second condition aiming to take into account a mobility of the transmitter device D_TX. More particularly, in this other exemplary embodiment, it is considered that the transmitter device D_TX is mobile at a speed V between instants at which the acquisition module MOD_ACQ acquires a measurement of an electromagnetic power coming from the source SO and the evaluation module MOD_EVAL evaluates the criterion CRIT. Therefore, said second condition of the criterion CRIT consists in verifying whether the duration separating said instants is sufficiently low compared to the ratio A/V, so that the electromagnetic power received by the transmitter device D_TX from the source SO via the ambient signal is substantially constant during said duration. In other words, it comes to guarantee that the conditions of illumination of the transmitter device D_TX remain stable over time, at least for said duration.

It is noted that said speed V can for example correspond to a speed defined in a telecommunications standard. According to another example, said speed V corresponds to a typical speed of displacement for the transmitter device D_TX (example: a speed of the order of 3 km/h for a Smartphone in possession of a walking user).

In these examples (speed defined by a standard or typical speed), said speed V corresponds to a data that can be stored in the storage means of the transmitter device D_TX during its design, such as for example in its non-volatile memory 4. Alternatively, said speed V is a data that can be stored by an ancillary device, such as for example a server storing a database, the transmitter device D_TX having access to this parameter thus stored by exchange of messages with said auxiliary device.

However, nothing excludes considering that the transmitter device D_TX is equipped with means configured to carry out measurements of its displacement speed V. Such means include for example an accelerometer.

For the rest of the description, and for the purpose of simplifying it, it is now considered that the transmitter device D_TX remains fixed over time. It is also considered that the criterion CRIT excludes a single condition to be verified, namely the condition according to which the coverage distance D_COUV belongs to the interval I_COUV.

It should also be noted that the evaluation of the criterion CRIT requires, in the present embodiment, to calculate the coverage distance D_COUV in accordance with the analytical expression given previously. This analytical expression in particular involves the coefficients A, r, G_TX and G_RX which can, in whole or in part, be defined in a telecommunications standard or be measured in the factory. In other words, the transmitter device D_TX has knowledge of these coefficients when it evaluates the criterion CRIT by means of its module MOD_EVAL.

According to considerations similar to those mentioned above concerning the speed V, all or part of said coefficients λ, r, G_TX and G_RX can be stored in storage means of the transmitter device D_TX during its design, or in an ancillary device.

In general, no limitation is attached to the way in which the transmitter device D_TX obtains the knowledge of said coefficients λ, r, G_TX and G_RX.

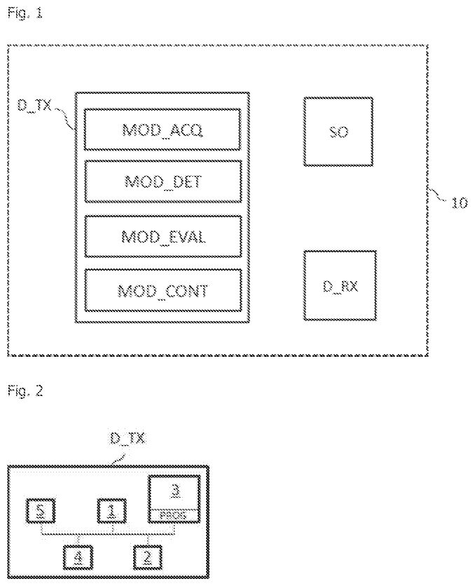

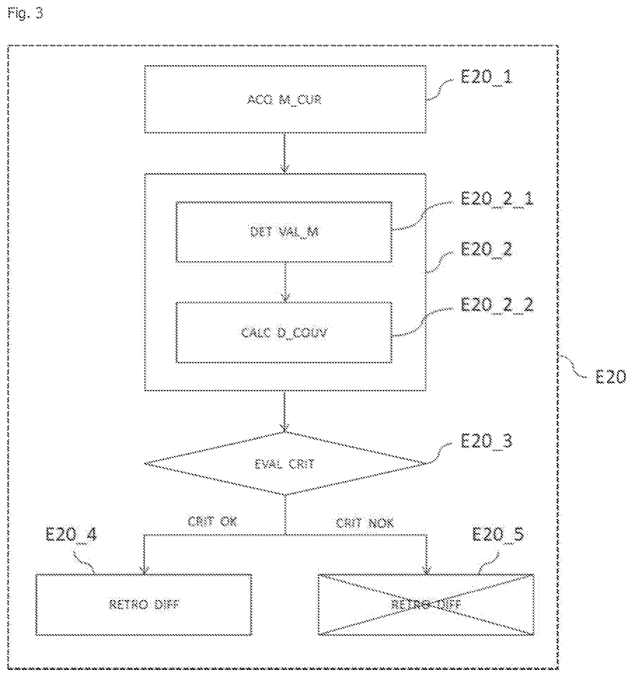

FIG. 3 represents, in the form of a flowchart, one particular embodiment of the control method according to the invention, as it is implemented by the transmitter device D_TX of FIG. 2.

The particular embodiment of FIG. 3 relates to a phase called “current phase” E20 of the control method. This current phase E20 includes a plurality of steps, and can be optionally preceded, according to other modes of implementation and as described later, by a preliminary phase during which various quantities can be determined so that the evaluation of the coverage distance D_COUV is performed according to an analytical expression different from the expression given above. In any event, with regard to the description of FIG. 3, it is considered that the coverage distance D_COUV is defined according to the expression considered so far, namely:

$$D\_COUV = \frac{λ}{4 \times π} \times {[ r \times G\_TX \times G\_RX \times \frac{VAL\_M}{VAL\_C} ]}^{1 / 2}$$

For the description of FIG. 3, it is also considered, without limitation, that the transmitter device D_TX is in the non-backscatter state when the control method is implemented.

As illustrated in FIG. 3, said current phase E20 includes a step E20_1 of acquisition of a measurement, called “current measurement” M_CUR, of an electromagnetic power received from the source SO via the ambient signal. Said step E20_1 is implemented by the acquisition module MOD_ACQ equipping the transmitter device D_TX.

Said current phase E20 also includes a step E20_2 of determination of the coverage distance D_COUV. Said step E20_2 is implemented by the determination module MOD_DET equipping the transmitter device D_TX.

In the mode of implementation of FIG. 3, said step 30 more particularly includes:
a sub-step E20_2_1 of determination of the value VAL_M of the signal to noise ratio on the transmitter device D_TX side from the current measurement M_CUR (this involves dividing M_CUR by P_NOISE(D_TX)). Said determination of the value VAL_M is implemented by a determination sub-module (not represented in the figures) of the determination module MOD_DET,
a sub-step E20_2_2 of calculation of the coverage distance D_COUV from the value VAL_M thus determined. Said calculation of D_COUV is implemented by a calculation sub-module (not represented in the figures) of the determination module MOD_DET.

Once the distance D_COUV has been determined, said current phase E20 includes a step E20_3 of evaluation of the criterion CRIT. Said step E20_3 is implemented by the evaluation module MOD_EVAL equipping the transmitter device D_TX.

In the present mode of implementation, said step E20_3 consists in verifying that the coverage distance D_COUV determined in step E20_2 belongs to the interval I_COUV, that is to say is comprised between the bounds D_MIN and D_MAX.

Therefore, if the criterion CRIT is satisfied (i.e. the coverage distance D_COUV belongs to the interval I_COUV), said current phase E20 includes a step E20_4 of backscattering of the ambient signal. Said step E20_4 is implemented by the control module MOD_CONT equipping the transmitter device D_TX.

Thus, if the criterion CRIT is verified, step E20_4 consists in implementing the backscattering of the ambient signal by the transmitter device D_TX. Therefore, the control module makes it possible to switch the transmitter device D_TX selectively from the non-backscatter state to the backscatter state (and vice versa) as a function of an information data that said transmitter device D_TX wishes to communicate to the receiver device D_RX.

However, nothing excludes envisaging that said implementation of the backscattering consists in switching the transmitter device D_TX from the non-backscatter state to the backscatter state, so that said transmitter device D_TX remains in said backscatter state.

Conversely, if the criterion CRIT is not satisfied, said current phase E20 includes a step E20_5 of absence of ambient backscattering of the ambient signal. Here again, said step E20_5 is implemented by the control module MOD_CONT equipping the transmitter device D_TX.

Insofar as the transmitter device D_TX is in the non-backscatter state when the current phase E20 of the control method begins, it is understood that said step E20_5 consists in maintaining the transmitter device D_TX in this non-backscatter state.

The control method has been described so far by considering that the transmitter device D_TX is in the non-backscatter state when the implementation of the steps of the current phase E20 begins. However, nothing excludes envisaging that the steps of the current phase E20 are implemented while the transmitter device D_TX is in the backscatter state. Consequently, if the criterion CRIT is satisfied following the execution of step E20_4, we can have, according to considerations similar to those described above, a selective alternation between said non-backscatter and backscatter states, or a holding of the transmitter device D_TX in said backscatter state. Conversely, if the criterion CRIT is not satisfied, the transmitter device D_TX switches from the backscatter state to the non-backscatter state by means of its control module MOD_CONT.

The invention has also been described so far by considering that the condition relating to the coverage distance D_COUV (belonging or not to the interval I_COUV) is verified directly during the evaluation of the criterion CRIT. By “directly verified”, reference is made here to the fact that it is explicitly verified whether the coverage distance D_COUV determined during step E20_2 is comprised between the bounds D_MIN and D_MAX of the interval I_COUV.

However, the invention also remains applicable when such verification is performed indirectly. By “indirectly verified”, reference is made here to the fact that another condition relating to a quantity distinct from said coverage distance D_COUV is verified, the result of the verification of said other condition providing a result similar to the one that would be obtained if the condition relating to the coverage distance D_COUV were verified.

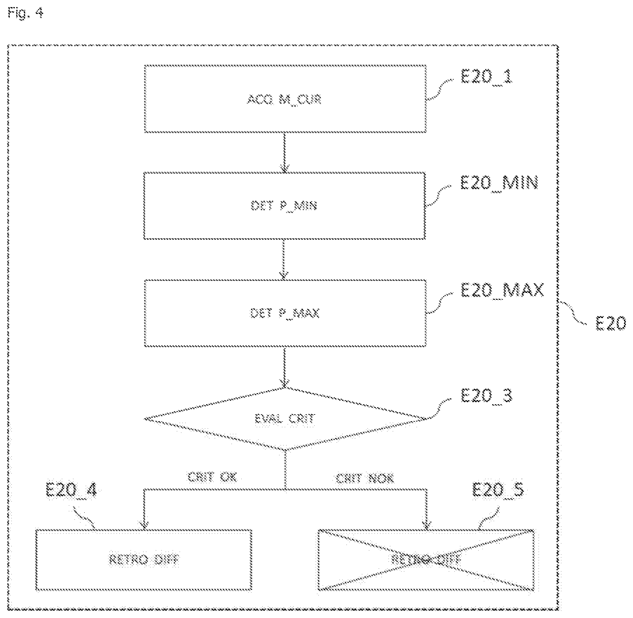

To illustrate the principle of an indirect verification of the condition relating to the coverage distance D_COUV, an alternative mode of implementation of the control method of the invention is considered with reference to FIG. 4, in which the criterion CRIT now consists in verifying a condition relating to the electromagnetic power received by the transmitter device D_TX from the source SO. More particularly, and as illustrated by FIG. 4, said current phase E20 includes, in this alternative mode of implementation and as a replacement for step E20_2 of FIG. 3:
a step E20_MIN of determination of an electromagnetic power, called “minimum power” P_MIN, which, if it is received by the transmitter device D_TX from the source SO, allows said target value VAL_C to be achieved at a distance equal to said lower bound D_MIN,
a step E20_MAX of determination of an electromagnetic power, called “maximum power” P_MAX, which, if it is received by the transmitter device D_TX from the source SO, allows said target value VAL_C to be achieved at a distance equal to said upper bound D_MAX.

In addition, the verification performed during the evaluation of the criterion CRIT (step E20_3) consists, in this alternative mode of implementation, in verifying whether the current measurement M_CUR is comprised between said minimum P_MIN and maximum P_MAX powers. In other words, in this alternative mode of implementation, the transmitter device D_TX is associated with a coverage constraint corresponding to an interval whose bounds are P_MIN and P_MAX, and in which the power received from the source SO must be comprised for the ambient signal backscattering to be implemented.

The values P_MIN and P_MAX are deduced from the analytical expression given above for the coverage distance D_COUV, considering that they are respectively associated with said lower D_MIN and upper D_MAX bounds. Thus, we have:

$$P\_MlN = \frac{VAL\_C \times P\_NOISE ( D\_TX )}{r \times G\_TX \times G\_RX} \times {( \frac{4 \times π \times D\_MlN}{λ} )}^{2}$$

$$and :$$

$$P\_MAX = \frac{VAL\_C \times P\_NOISE ( D\_TX )}{r \times G\_TX \times G\_RX} \times {( \frac{4 \times π \times D\_MAX}{λ} )}^{2}$$

Ultimately, in said alternative mode of implementation, verifying that the current measurement M_CUR is comprised between P_MIN and P_MAX is completely equivalent to verifying that the coverage distance D_COUV is comprised between D_MIN and D_MAX.

It is important to note that the implementation of the method according to the invention is not limited to the embodiments of FIGS. 3 and 4. Particularly, for these embodiments, it was considered that the coverage distance D_COUV could be determined by means of the analytical expression described above. However, other embodiments remain possible, in which said analytical expression is not used.

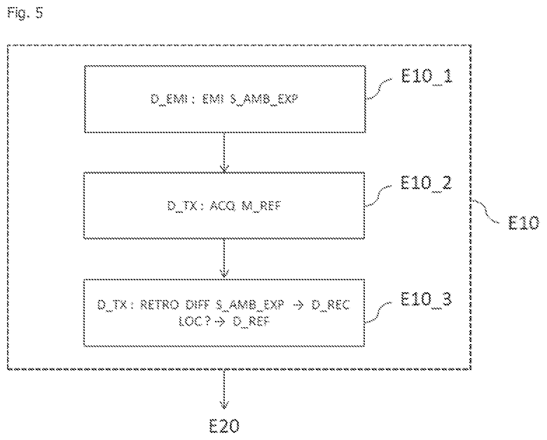

FIG. 5 represents, in the form of a flowchart, another particular mode of implementation of the control method according to the invention.

In the embodiment of FIG. 5, the control method includes a preliminary experimental phase E10, for example carried out in the factory, during which the transmitter device D_TX is fixed and comprising a plurality of steps.

Also, said preliminary phase E10 initially includes a step E10_1 of emission of an ambient signal, called “experimental ambient signal” S_AMB_EXP, by an emitter device D_EMI.

Said emitter device D_EMI can for example correspond to the source SO considered previously, or to a device distinct from said source SO.

The preliminary phase E10 also includes a step E10_2 of acquisition, by the transmitter device D_TX, of a measurement, called “reference measurement” M_REF, of an electromagnetic power received from the emitter device D_EMI via the experimental ambient signal S_AMB_EXP. The implementation of said step E10_2 is similar to that of step E20_1 described previously.

It is also noted that said reference measurement M_REF can for example be used for the determination, by the transmitter device D_TX, of a value VAL_REF of a signal to noise ratio on the transmitter device D_TX side.

The preliminary phase E10 also includes a step E10_3 of ambient backscattering of the experimental ambient signal S_AMB_EXP by the transmitter device D_TX and to a receiver device D_REC configured to decode said backscattered experimental ambient signal. It should be noted that the receiver device D_REC can for example correspond to the receiver device D_RX mentioned above.

Said preliminary phase E10 further comprises, during the execution of said ambient backscatter step E10_3, a search for a location LOC at which the backscattered experimental ambient signal S_AMB_EXP is received by the receiver device D_REC with a reception quality achieving said target value VAL_C.

This search for the location LOC is for example implemented thanks to an operator in charge of moving the receiver device D_REC, so that once moved, said receiver device D_REC can carry out an acquisition of a measurement of an electromagnetic power received from the transmitter device D_TX and determine, based on this power measurement, the signal to noise ratio at its level. Consequently, when the target value VAL_C is achieved after a displacement, the receiver device D_REC can for example emit a message to the transmitter device D_TX to inform it.

According to another example, the receiver device D_REC corresponds to a mechatronic device (for example a robot) including drive means (such as for example an electric or thermal motor, etc.) as well as displacement means (such as for example wheels, caterpillars, etc.) allowing it to move autonomously or remotely.

The distance separating the receiver device D_REC from the transmitter device D_TX when such a location LOC has been found is called “reference distance” D_REF. The transmitter device D_TX then becomes aware of this reference distance D_REF, no limitation being attached to the way in which this awareness takes place (examples: reference distance D_REF noted by the operator then stored in storage means of the transmitter device D_TX; receiver device D_REC equipped with distance measuring means, the reference distance D_REF therefore being measured by said receiver device D_REC that communicates it to the transmitter device D_TX).

Ultimately, in the mode of implementation of FIG. 5, said coverage distance D_COUV is defined as follows:

$$D\_COUV = D\_REF \times {( \frac{VAL\_M}{VAL\_REF} )}^{1 / 2}$$

Such an expression of D_COUV indicates that D_COUV is, in this mode of implementation, defined as a function of:
the reference distance D_REF,
the reference measurement M_REF, given the presence of the term VAL_REF,
the current measurement M_CUR, given the presence of the term VAL_M,
the target value VAL_C, given the presence of the term D_REF. Consequently, once the experimental phase has been completed, the control method again

includes, in the mode of implementation of FIG. 5, a current phase E20. This current phase E20 is similar to those described above with reference to FIGS. 3 and 4, except that the expression used to determine the coverage distance D_COUV or to express the power received by the transmitter device D_TX from the source SO is the expression given above in which the quantities D_REF and VAL_REF are involved.

On a complementary basis, it can again be noted that the last expression of D_COUV given above implicitly takes into account the fact that the power spectral density of the experimental ambient signal S_AMB_EXP is substantially identical during the respective executions of said steps of acquisition E10_1 of the reference measurement M_REF and of the ambient backscattering E10_3 of the experimental ambient signal S_AMB_EXP. Nevertheless, in case said spectral density varies between these instants, it is possible to take account this variation in the expression of D_COUV according to technical characteristics similar to those described previously.

The invention has also been described so far by considering that, with regard to the current phase of the control method, a receiver device D_RX belongs to the ambient backscatter communication system 10. It is then understood that the fact of considering the presence of such a receiver device D_RX makes it possible to envisage a particularly advantageous application of the invention in the framework of D2D communications, the transmitter device D_TX now being able to control its coverage, unlike what is practiced in the state of the art.

Nevertheless, the invention remains applicable to the case where said system 10 does not include a receiver device D_RX during the implementation of said current phase, the transmitter device D_TX therefore, for example, simply backscatters the ambient signal without specifically seeking to transmit an information data specific thereto.

1. A method for controlling the ambient backscattering of an ambient signal emitted by an emitter device, said method including a current phase implemented by a transmitter device configured to backscatter said ambient signal and comprising steps of:
acquisition of a current measurement of an electromagnetic power received from the emitter device via the ambient signal,
evaluation of a criterion by at least verifying whether a coverage distance counted from a position occupied by the transmitter device during the acquisition of the current measurement and in which is achieved a given target value of quality of reception of a signal obtained by ambient backscattering of the ambient signal, is in a given interval, said coverage distance being defined as a function of said current measurement and said target value, and
upon a determination that said criterion is satisfied, ambient backscattering of the ambient signal.

2. The method of claim 1, wherein said target value is a value of any one of the following quantities:
a signal to noise ratio,
a signal to interference plus noise ratio, and
a bit error rate.

3. The method of claim 1 2, wherein the ambient signal is characterized by:
a first spectral density when the acquisition of the current measurement (M_CUR) is executed, and
a second spectral density, distinct from said first spectral density, when the evaluation of the criterion is executed,
said coverage distance also being defined as a function of the ratio between said first and second power spectral densities.

4. The method of claim 1, wherein the transmitter device is configured to backscatter said ambient signal to at least one receiver device, said receiver device being configured to decode said backscattered ambient signal, said transmitter and receiver devices being respectively characterized by antenna gains G_TX and G_RX, said coverage distance also being defined as a function of said antenna gains G_TX and G_RX.

5. The method of claim 1, said method including, before the implementation of said current phase, a preliminary experimental phase during which the transmitter device is fixed and comprising steps of:
acquisition, by the transmitter device, of a reference measurement of an electromagnetic power received from an emitter device emitting an experimental ambient signal, and
ambient backscattering of the experimental ambient signal by the transmitter device and to a receiver device configured to decode said backscattered experimental ambient signal,
said preliminary experimental phase further comprising, during the execution of said ambient backscattering, searching for a location at which the backscattered experimental ambient signal is received by the receiver device with a reception quality achieving said target value, the distance separating the receiver device from the transmitter device when such a location has been found being a reference distance, and said coverage distance also being defined as a function of said reference measurement and said reference distance.

6. The method of claim 1, wherein said current phase further includes a step of determination of the coverage distance, said at least one verification performed during the evaluation of the criterion comprising a direct verification that the determined coverage distance belongs to said interval.

7. The method of claim 1, wherein the interval associated with the coverage distance includes a lower bound and an upper bound, said current phase further including steps of:
determination of an electromagnetic minimum power, which, if it is received by the transmitter device from the emitter device, allows said target value to be achieved at a distance counted from the position occupied by the transmitter device during the acquisition of the current measurement and equal to said lower bound, and
determination of an electromagnetic maximum power which, if it is received by the transmitter device from the emitter device, allows said target value to be achieved at a distance counted from the position occupied by the transmitter device during the acquisition of the current measurement and equal to said upper bound,
said at least one verification performed during the evaluation of the criterion comprising verifying whether the current measurement is comprised between said minimum and maximum powers.

8. The of claim 1, wherein the transmitter device is movable at a speed V between times at which said steps of acquisition and evaluation of said current phase are executed, the evaluation of the criterion also consisting in verifying whether the duration separating said execution times is sufficiently short compared to a ratio λ/V, where λ corresponds to the wavelength of the carrier frequency of the ambient signal, so that the electromagnetic power received by the transmitter device from the emitter device via the ambient signal is substantially constant during said duration.

9. (canceled)

10. A non-transitory computer-readable medium having stored thereon instructions which, when executed by a processor, cause the processor to implement the method of claim 1.

11. A transmitter device for controlling the ambient backscattering of an ambient signal emitted by an emitter device, said transmitter device being configured to backscatter said ambient signal and comprising:
an acquisition module configured to acquire a current measurement of an electromagnetic power received from the emitter device via the ambient signal,
an evaluation module configured to evaluate a criterion by at least verifying whether a coverage distance counted from a position occupied by the transmitter device during the acquisition of the current measurement and at which is achieved a given target value of quality of reception of a signal obtained by ambient backscattering of the ambient signal, is in a given interval, said coverage distance being defined as a function of said current measurement and of said target value, and
a control module (MOD_CONT) configured:
to implement backscattering of the ambient signal upon a determination that the criterion is satisfied, and
not to implement backscattering of the ambient signal upon a determination that said criterion is not satisfied.

12. An ambient backscatter communication system, said system including an emitter device configured to emit an ambient signal and the transmitter device of claim 11.
